(19) United States
(12) Patent Application Publication
(10) Pub. No.: US 2005/0104998 A1
(43) Pub. Date: May 19, 2005

(54) Camera apparatus

(76) Inventor: Toru Udaka, Kanagawa (JP)

Correspondence Address: FROMMER LAWRENCE & HAUG LLP, 745 FIFTH AVENUE, NEW YORK, NY, 10151, US

(21) Appl. No.: 10/952,298

(22) Filed: Sep. 27, 2004

(30) Foreign Application Priority Data
Sep. 29, 2003 (JP) 2003-337152

(51) Int. Cl. H04N 5/238

(52) U.S. Cl. 348/363

(57) ABSTRACT

This invention is configured so as to ensure a maximum transmittance of a light at a low illumination, by employing a structure of a light control unit to be disposed in and escaped from the optical path, in integration or cooperation with, for example, a general purpose IR cut filter to be disposed within the optical path. By moving the liquid crystal element for light by an existing IR cut filter moving mechanism, there is the advantage of realizing a camera apparatus of a superior function at low cost, while minimizing components to be newly added.

### CROSS REFERENCE TO RELATED APPLICATION

This application claims priority from Japanese Priority Document No. 2003-337152, filed on Sep. 29, 2003 with the Japanese Patent Office, which document is hereby incorporated by reference.

### BACKGROUND OF THE INVENTION

1. Field of the Invention

The present invention relates to a camera apparatus, such as a digital camera and a video camera having a light control function.

2. Description of the Related Art

Heretofore, camera apparatuses such as digital cameras and video cameras have been known, wherein each of which has an imaging unit for capturing an image signal by performing photoelectric conversion of an optical image of an object, and a camera body unit for recording this image signal in a recording medium such as a semiconductor memory, an optical disk, a magnetic tape, etc. after performing a predetermined signal processing to the captured image signal, and, in this case, the imaging unit is attached rotatably to the camera body unit. For example, in a video camera using a CCD (Charge Coupled Device) device, a light from an object is irradiated via an optical lens to an imaging surface of the CCD device, and the CCD device performs photoelectric conversion of the light from the object to generate an electric signal. Thus generated electric signal is read out by a read control signal supplied from a read circuit, and then converted to a video signal. This video signal is subjected to shading correction and various level corrections, and after performing a signal processing to this video signal, this video signal is outputted. In such video cameras, by an automatic diaphragm mechanism such as so-called auto iris, the amount of light from the object is automatically adjusted, and then, thus adjusted light is supplied to the CCD device. For example, in the case of shooting an extremely bright scene, this diaphragm mechanism might become such a small diaphragm aperture position as to cause optical diffraction phenomenon.

Therefore, in the case of shooting a brighter scene than a scene having its brightness corresponding to a diaphragm position somewhat nearer than a diaphragm position where the above-mentioned optical diffraction phenomenon begins, its sensitivity has heretofore been moderated with the intention of user by the method of attaching an ND (Neutral Density) filter for moderating brightness to a video camera, or of employing the function so-called electronic shutter that the charge storage time in the CCD device is made variable by using in a shutter priority mode in which the original shutter operation has priority over the diaphragm operation. As an element for adjusting an amount of light (a light control unit), there has been known one utilizing a guest-host type liquid crystal element with use of absorption anisotropy of dichromatic pigment (for example, see Japanese Laid-Open Patent No. 11-326894). The characteristic of a variable ND filter can be obtained by utilizing such a guest-host type liquid crystal element, as an element for adjusting the amount of light.

FIG. 4 is an explanatory diagram showing an example of the configuration of an imaging unit of a camera apparatus utilizing such a guest-host type liquid crystal element, as an element for adjusting the amount of light. In this imaging unit, as depicted in this figure, a lens group 212 constituting an imaging optical system is disposed ahead of an imaging element 210 composed of a CCD device, a CMOS (Complementary Metal Oxide Semiconductor) device, etc., and an IR (Infra Red) cut filter 214 and a liquid crystal filter 216 composed of a guest-host type liquid crystal element are disposed in-between and in parallel. The IR cut filter 214, which is utilized at the time of a shooting other than an infrared shooting at night, and the like, is controlled as to be moved as indicated by the arrow β, and is escaped from an optical path by a moving mechanism (not shown) when not in-use. On the other hand, the liquid crystal filter 216 is fixedly disposed within the optical path, and functions as a variable ND filter.

Meanwhile, in cases where the above-mentioned guest-host type liquid crystal element is utilized as an element for adjusting the amount of light, a liquid crystal element of pigment-containing type is disposed within the optical path, and hence there is the problem that even at the time of a low brightness shooting requiring no limitation to the amount of light, a transmittance of light drops at the liquid crystal element and the maximum transmittance of the light is lowered to hinder an optimum shooting characteristic. Accordingly, the present invention has as its aspect to provide a camera apparatus that is able to prevent any deterioration in its characteristic at a low brightness shooting, which is caused by the drop in the transmittance of light due to a light control unit using a liquid crystal element of pigment-containing type, thereby to improve its shooting characteristic.

### SUMMARY OF THE INVENTION

In order to achieve the above aspect, a camera apparatus in accordance with the present invention is characterized by having an imaging element for performing imaging of an object; an imaging optical system that is disposed ahead of the imaging element and leads an incident light from the object to the imaging element; a light control unit that is disposed within an optical path between the imaging optical system and the imaging unit, and that is composed of a liquid crystal element of a pigment-containing type for making a light control of the incident light; moving control means for escaping the light control unit outside the optical path; and selection means for selecting whether the light control unit should be escaped or not by the moving control means.

In accordance with the camera apparatus of the present invention, by virtue of the configuration that the liquid crystal element of the pigment-containing type for making the light control of the incident light is disposed within the optical path between the imaging optical system and the imaging unit, and the light control unit is escaped outside the optical path, the light control unit is able to be escaped outside the optical path, for example, at the time of a low brightness shooting. Thereby, the drop in its transmittance of the incident light due to the liquid crystal element of the pigment-containing type is eliminated to prevent deterioration in its characteristic, thereby enabling to improve the shooting characteristic.

### BRIEF DESCRIPTION OF THE DRAWINGS

FIG. 1 is an explanatory diagram showing an example of the configuration of an imaging unit of a camera apparatus in accordance with one preferred embodiment of the present invention;

FIG. 2 is a block diagram showing an example of the overall configuration of the camera apparatus in which the imaging unit shown in FIG. 1 is disposed;

FIG. 3 is an explanatory diagram showing an example of measurements of transmittance characteristics when the liquid crystal filter composed of the guest-host type liquid crystal element is escaped outside an optical path, and when disposed within the optical path; and

FIG. 4 is an explanatory diagram showing an example of the configuration of an imaging unit of a camera apparatus in accordance with a conventional case.

### DETAILED DESCRIPTION OF THE PREFERRED EMBODIMENT

In cases where a light control unit composed of a liquid crystal element is utilized in an imaging unit of a camera apparatus, the characteristic of a variable ND filter can be obtained by using, for example, a guest-host type liquid crystal element using dichromatic pigment. However, in the case of using this guest-host type liquid crystal element, there arises the problem that if this guest-host type liquid crystal element is always disposed within the optical path, it is unavoidable to sacrifice a maximum transmittance of a light because the pigment is contained in advance in the liquid crystal element. Therefore, it is configured so as to ensure a maximum transmittance of a light at a low illumination, by employing the structure of having the light control unit to be disposed in and escaped from the optical path, in integration or cooperation with, for example, a general purpose IR cut filter disposed within the optical path. By moving the liquid crystal element for light control with an existing IR cut filter moving mechanism, there is the advantage of realizing a camera apparatus of a superior function at low cost, while minimizing components to be newly added.

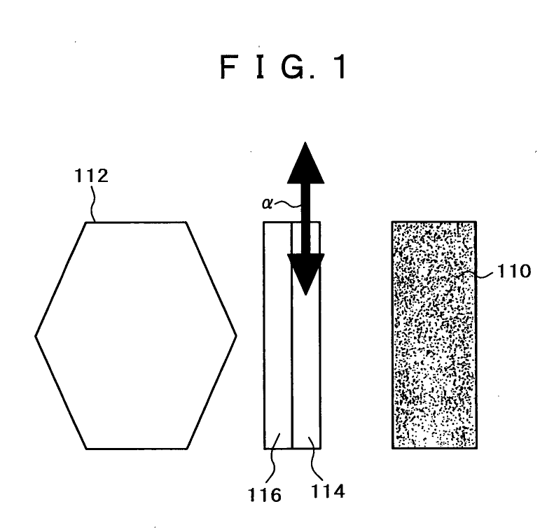

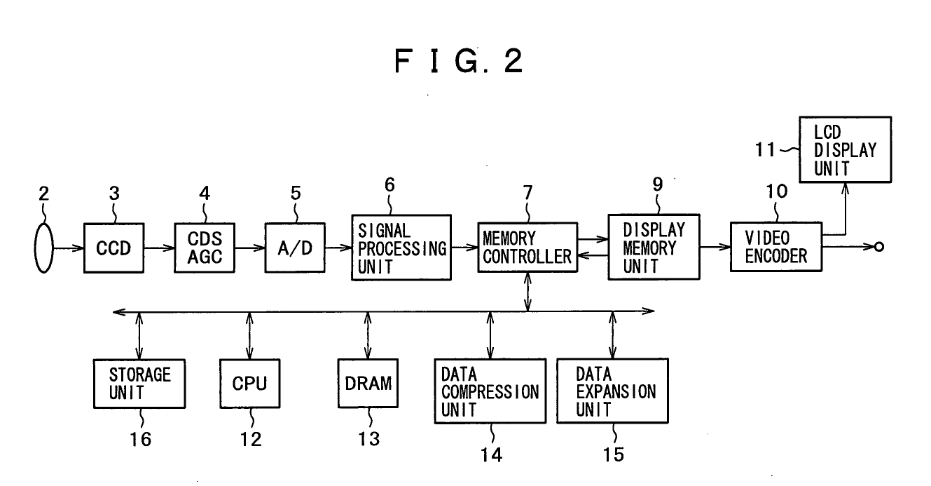

FIG. 1 is an explanatory diagram showing an example of the configuration of an imaging unit of a camera apparatus in accordance with the present invention. FIG. 2 is a block diagram showing an example of the overall configuration of the camera apparatus in which the imaging unit shown in FIG. 1 is disposed. As shown in FIG. 1, in the imaging unit of the camera apparatus in this preferred embodiment, a lens group 112 constituting an imaging optical system is disposed ahead of an imaging element 110 composed of a CCD device, a CMOS device, etc., and there-between, an IR cut filter 114, and a liquid crystal filter 116 composed of a guest-host type liquid crystal element are disposed and integrally arranged. The IR cut filter 114 is provided to utilize at the time of a shooting other than an infrared shooting at night, and the like. The liquid crystal filter 116 is provided to function, together with the IR cut filter (for cutting off IR ray) 114, as a variable ND filter for making a light control at the time of a normal shooting. In this preferred embodiment, by a moving mechanism (not shown), the IR cut filter 114 and the liquid crystal filter 116 are controlled as to be moved integrally, and escaped from an optical path when not in-use, as indicated by the arrow α. As a moving mechanism, it is able to use actuators of various types, which may be one that employs, for example, a piezoelectric element and a solenoid plunger, as a driving source. The output of the imaging element 110 is processed by a light amount measuring circuit (not shown) so as to make measurement of the amount of light of the total incident light. If the detected value of the amount of light is not more than a predetermined specified value, it is judged as a low brightness shooting, and the IR cut filter 114 and the liquid crystal filter 116 are escaped from the optical path, so that a shooting with an enlarged transmittance to a maximum is performed.

Instead of so making the light amount measurement by the output of the imaging element 110, the measurement may be made by disposing a dedicated sensor for a light amount measurement within the optical path. Alternatively, there may employ the following configuration that a sensor for measuring the luminosity of surroundings is disposed at, for example, a casing of the camera apparatus, and it is judged whether the IR cut filter 114 and the liquid crystal filter 116 should be escaped or not from the optical path, based on the detected value of the sensor. In addition, as to whether the IR cut filter 114 and the liquid crystal filter 116 should be disposed within the optical path or escaped outside the optical path, it may be done, for example, based on a mode selection of user, other than the control based on the light amount measurement.

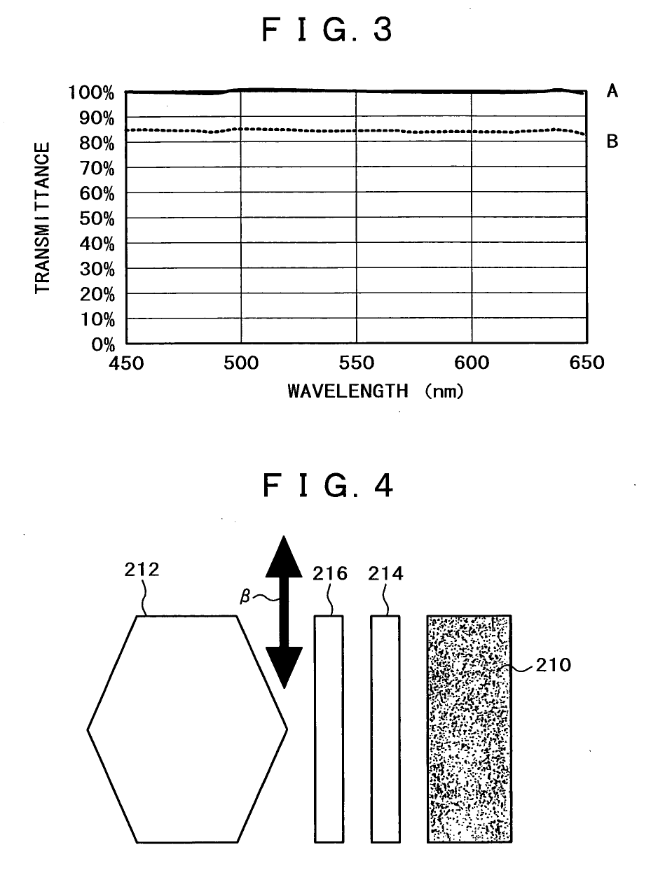

FIG. 3 is an explanatory diagram, on which the abscissa represents wavelength and the ordinate represents transmittance, indicating an example of measurements of the transmittance characteristics when the liquid crystal filter composed of the guest-host type liquid crystal element is escaped outside the optical path, and when disposed within the optical path. The depicted transmittance characteristics indicate the values obtained by eliminating influence factors other than the filter. As depicted, it can be seen that the solid line A, which represents a maximum transmittance when the IR cut filter 114 and the liquid crystal filter 116 are escaped from the optical path by the function of this preferred embodiment, indicates an approximately 100%, and the broken line B, which represents a maximum transmittance when the liquid crystal filter is fixedly disposed within the optical path (a conventional example), indicates that there causes a loss of about 15%.

The outline of the camera apparatus of this preferred embodiment will next be described by referring to FIG. 2. As depicted, this camera apparatus has an object lens 2 (corresponding to the lens group 112), a CCD imaging unit 3 (including the IR cut filter 114, the liquid crystal filter 116, and the imaging element 110), a CDS/AGC (Correlated Double Sampling/Automatic Gain Control) unit 4, an A/D conversion unit 5, a signal processing unit 6, a memory controller 7, a display memory unit 9, a video encoder 10, an LCD display unit 11, a CPU 12, a DRAM 13, a data compression unit 14, a data expansion unit 15, a storage unit 16, and the like. In this camera apparatus, an image of an object is shot by the CCD imaging unit 3 through the object lens 2, and the like. The shot image data is passed through the CDS/AGC unit 4 in order to perform noise elimination and a gain adjustment, and then converted to digital data at the A/D conversion unit 5. After being subjected to signal processing, such as color adjustment at the signal processing unit 6, this digital image data is passed through the memory controller 7, the display memory unit 9 and the video encoder 10, and then displayed on the LCD display unit 11. Further, with use of the DRAM 13 and the data compression unit 14, the image data subjected to signal processing at the signal processing unit 6 is compressed and stored in the storage unit 16. The stored image data is then called from the storage unit 16, and expanded by using the DRAM 13 and the data expansion unit 15. This image is then passed through the memory controller 7, the display memory unit 9, and the video encoder 10, and then displayed on the LCD display unit 11. Here, the CPU 12 regulates the entire control of this camera apparatus.

In this camera apparatus, the CPU 12 judges the measured value of a light amount fetched from the CCD imaging unit 3, and functions as selection means for selecting whether the IR cut filter 114 and the liquid crystal filter 116 should be disposed within the optical path or escaped outside the optical path by the drive of the above-mentioned moving mechanism, and controlling the moving mechanism in response to the selection result. In the configuration that whether the IR cut filter 114 and the liquid crystal filter 116 should be disposed within the optical path or not is selected on the basis of a mode selection of user, as described above, the CPU 12 monitors a mode selection input from an operation key (not shown), and, if a mode selection by user arises, the CPU 12 controls the moving mechanism in response to a meaning of the selection.

The camera apparatus to which the present invention is implemented is not limited to the configuration as shown in FIG. 2, but applicable widely to camera apparatuses of various types requiring a delicate light control. The liquid crystal element of the pigment-containing type is not limited to the guest-host type liquid crystal element, but other liquid crystal elements are usable. Additionally, although the foregoing preferred embodiment employs the configuration that the IR cut filter and the liquid crystal filter are integrally moved, the present invention is practicable in a camera apparatus having no IR cut filter, which is configured such that a liquid crystal filter for the light control is able to be moved individually, or an IR cut filter and a liquid crystal filter are able to be moved, individually.

In the camera apparatus in accordance with the foregoing preferred embodiment of the present invention, by the liquid crystal filter composed of the guest-host type liquid crystal element, the amount of incident light can be adjusted delicately to perform an appropriate shooting, and, as needed, this liquid crystal filter is escaped outside the optical path in order to perform a shooting with the enhanced transmittance of incident light to a maximum, thereby enabling to provide the camera apparatus that can effectively comply with a variety of shootings. As the configuration that an optical filter is disposed in and escaped from an optical path in conventional camera apparatuses, there is, for example, one disclosed in Japanese Patent No. 2873694. However, this is proposed to dispose and escape an optical filter attached to a conventional diaphragm unit, and hence differs from one in which the liquid crystal element is independently disposed in and escaped from the optical path in order to adjust the amount of light, as in the present invention. Therefore, the present invention has inherent configuration and operational effect.

1. A camera apparatus comprising:
an imaging element for performing imaging of an object;
an imaging optical system disposed ahead of the imaging element and leads an incident light from the object to the imaging element;
a light control unit disposed within an optical path between the imaging optical system and the imaging element for performing a light control of the incident light by using a liquid crystal element of a pigment-containing type;
moving control means for removing the light control unit outside the optical path; and
selection means for selecting whether the light control unit should be escaped or not by the moving control means.

2. The camera apparatus as cited in claim 1, further comprising:
light amount measuring means for measuring a light amount of the incident light, wherein;
said selection means judges whether the light control unit is escaped or not from the optical path based on a measured value by the light amount measuring means.

3. The camera apparatus as cited in claim 2, wherein;
said selection means selects to escape the light control unit to outside of the optical path when the measured value of the incident light by the light amount measuring means becomes below a predetermined value.

4. The camera apparatus as cited in claim 1, further comprising:
mode input means for inputting a shooting mode, wherein;
said selection means selects whether the light control unit is escaped or not from the optical path based on an input value from the mode input means.

5. The camera apparatus as cited in claim 1, wherein;
said liquid crystal element of a pigment-containing type is a guest-host type liquid crystal element.

6. The camera apparatus as cited in claim 1, further comprising:
an IR cut filter unit disposed within the optical path between the imaging optical system and the imaging element for cutting off an IR ray included in the incident light, wherein;
said moving control means escapes both the light control unit and the IR cut filter unit to outside of the optical path integrally or in coupled form.
